(19) United States
(12) Patent Application Publication
(10) Pub. No.: US 2003/0160736 A1
(43) Pub. Date: Aug. 28, 2003

(54) Portable heads-up display for vehicle

(76) Inventors: Charles M. Faso, Park Ridge, IL (US); Rudolph W. Lindich JR., Wilmette, IL (US)

Correspondence Address: GREER, BURNS & CRAIN, LTD., Suite 2500, 300 South Wacker Drive, Chicago, IL, 60606, US

(21) Appl. No.: 10/082,641

(22) Filed: Feb. 25, 2002

(51) Int. Cl. G09G 5/00

(52) U.S. Cl. 345/8

(57) ABSTRACT

A heads-up display device for presenting information to a viewer in a vehicle having a windshield and a dashboard includes a housing being positionable on the dashboard of the vehicle and an input device disposed in the housing for acquiring information. A display of the information is generated in the housing and provides the information as a mirror image that is directly reflected off the windshield to the viewer in readable format.

### BACKGROUND OF THE INVENTION

The present invention relates to a device for displaying information in a vehicle. More specifically, the invention relates to a portable device that displays non-critical information in an area easily viewed by the driver.

Operation of electronic devices, such as cellular telephones, pagers, personal data assistants (“PDAs”) and other portable electronic devices having readable displays, while driving has become a common occurrence. Most users of a cell phone view the cell phone display both when initiating and receiving a call. From focusing on a driving scene approximately 30 feet away, the driver must turn his head in the direction of the device, tilt the head, then refocus his eyes to an object approximately 2 feet away. Head changes and eye focus changes while driving can cause the driver to become disoriented, leading to a potentially unsafe condition. The level of an operator's disorientation is directly related to the amount of change in the line of sight, the length of time the distraction persists and the physical abilities of the driver. It can be easily demonstrated that most drivers start to become disoriented after only one second if the line of sight is significantly moved from the driving scene and information is assimilated from a nearby source.

Further, when traveling at typical highway speeds, a driver has only a second or two reaction time to avoid an accident should a dangerous condition arise. If a dangerous condition arises at the same time an incoming cell phone call is being handled, it may be too late to identify the dangerous condition, decide what to do and take preventative measures to avoid the condition were the driver to look down at the phone, assimilate the display information, and then return his gaze to the driving scene. Legislators in some states are considering banning the use of cell phones and other such electronic devices by the driver of a moving vehicle due to the potential for distraction of the driver.

Automobile warning systems are known that use a “heads-up” display, meaning that the driver does not have to look down to the instrument panel to ascertain the condition of his vehicle. For example, these systems employ a portion of the windshield to display warning messages related to the status of the vehicle. The information of interest is shown in an area that is within the driver's normal field of vision when viewing the road scene. When a warning is required, the information displayed appears as a virtual image superimposed on the road scene, instantly alerting the driver of increased danger or a condition of the vehicle that requires attention. This type of display is particularly beneficial because the driver need not turn his eyes or his attention from the road and thereby, there is reduced disorientation from head or eye focus changes.

Displays of prior art devices have generally used optical systems incorporating optical power to direct and/or enlarge the information, or lengthen the focal length for the viewer. Projection systems are used that include lenses, mirrors, and holograms to optically modify the information in some fashion. Although projection displays can produce more versatile views of the information, they are also expensive, tend to be larger than flat panel displays and tend to be hard-mounted in the vehicle. Size, particularly thickness, is important for a device that is placed on the dashboard of a vehicle. Thick devices will be limited in placement, or will have to be built into the dash in order to fit in the space between the dash and the windshield.

Some prior art displays employ a portion of the windshield having a reflective coating to display vehicle information or warning messages. The display is then reflected off of that portion of the windshield, appearing superimposed on the driving scene. Although this type of device reduces disorientation, limitation of the display to a predetermined position may not only be inconvenient, but be difficult for drivers of different statures to see, particularly those who are very short. Because the windshield is specially treated, the windshield is more expensive. In addition, use of the device is limited to that vehicle having the treated windshield. Some states limit the use of films or coatings on windshields due to potential reduction in visibility.

Prior art also discloses several units built into a vehicle to display the vehicle's speed in the driver's field of vision. U.S. Pat. No. 5,321,415 discloses a method for displaying the speed of a vehicle on the windshield of a vehicle using a series of diodes. The system as taught cannot vary messages and cannot be moved from one vehicle to another. Another display is taught in U.S. Pat. No. 5,677,701 for a unit that secures to the dashboard and has a display whose position can be varied within the driver's view. The information to be displayed is projected onto a tilting hologram combiner, having optical power and high reflectivity for a given color, that allows variation in the vertical position of the display by adjusting the tilt of the combiner. This apparatus reduces the time needed for the driver to ascertain his speed, and may reduce disorientation, however, the hologram combiner is expensive, the image is monochrome and the apparatus is limited to the vehicle into which it is installed.

It is, therefore, an object of this invention to provide an improved display for information from a cellular phone or other portable electronic device that is less distracting to the driver.

It is another object of this invention to provide an improved portable display device that is useful in any vehicle without modification to the vehicle.

It is still another object of this invention to provide an improved display unit that is usable in a vehicle for displaying information obtained externally to the vehicle.

It is yet another object of this invention to provide an improved display for information that is portable and is movable from one vehicle to another.

It is another object of this invention to provide an efficient, low cost display requiring no optical system incorporating power optics.

### SUMMARY OF THE INVENTION

These and other objects are met or exceeded by the present invention which features a portable display device that allows the user to move the device to any vehicle and position it within the vehicle to display information outside of the viewer's direct line of sight, but within the viewer's field of view.

More specifically, one embodiment of the present invention provides a heads-up display device for presenting information to a viewer in a vehicle having a windshield and a dashboard. The device includes a housing being positionable on the dashboard of the vehicle and an input means disposed in the housing for acquiring extravehicular information. A display of the information is generated in the housing and presents the information as a mirror image that is directly reflected off the windshield.

Another embodiment of the invention includes a housing that is positionable on the dashboard and an input for acquiring information. The display is generated in the housing, providing the information as a mirror image that is directly reflected from a location on the windshield outside the viewer's direct line of sight.

In still another embodiment of this invention, the housing is freely positionable on the dashboard. The input means acquires information that is shown on the display. The mirror image is directly reflected from a location on the windshield that is determinable by the position of the housing on the dashboard.

The display device accepts information from a wide variety of sources. It is possible to display any information that would tend to distract the driver if he were required to look away from the driving scene. Information displayed by this device is not limited to that generated within the vehicle, such as the vehicle speed, warning conditions or data generated by the display device. The device also accepts data from one or more extravehicular sources such as by cable from electronic devices, by wireless via infrared or RF receiver, or by cellular modem. Traffic reports, weather reports, maps, stock market data could all be obtained from outside the vehicle and displayed in a manner so as to be less of a distraction to the driver than trying to get the information directly from electronic devices inside the vehicle.

When the information is displayed, as in the preferred embodiment, above or below the driver's line of sight, it does not impair his vision of the road. However, if it becomes necessary to access information, such as from a map, the slight movement of the eyes up or down on the windshield allows the driver to return his focus to the driving scene much faster than having to turn away to view a separate display. Further, less disorientation will be experienced by the driver since eye focus change to another position on the windshield is less severe than focusing on a separate display away from the driving scene and closer to the viewer.

Preferably, the device is portable and can be used in any vehicle without modification to the vehicle. The display device can be wholly contained within the housing, making it easy to take the unit from one vehicle to another. Because the device is not necessarily hard-wired to the vehicle, no modification to the vehicle is required. Portability of the unit also allows it to be placed on the dashboard in any position that makes the display comfortably read by the viewer, regardless of the viewer's height or other physical limitations.

It is also preferred that the information be reflected on the windshield in a position that is out of the viewer's direct line of sight, so as to provide little distraction to a driver. Versatility in the placement of the display device allows the display to be reflected from almost any location on the windshield. At the convenience of the viewer, the information can be displayed above, below, to the right or to the left of the viewer's normal line of sight. Depending on the viewer's physical requirements, such as height or vision limitations, glare on the windshield, the angle at which sunlight enters the windshield, or other conditions, the display can be moved to accommodate the viewer.

A further feature of this device is that it does not require an optical system incorporating power optics to place the display within convenient sight of the viewer. Flat panel displays, such as those used in calculators or PDAs, are suitable to display information to the viewer as reflected in the vehicle's windshield, minimizing both the cost and the size of the device.

The ability of a driver to deal with multiple tasks while driving is not addressed by use of the device of this invention. However, this invention is believed to significantly reduce the overall level of distraction.

### DETAILED DESCRIPTION OF THE DRAWINGS

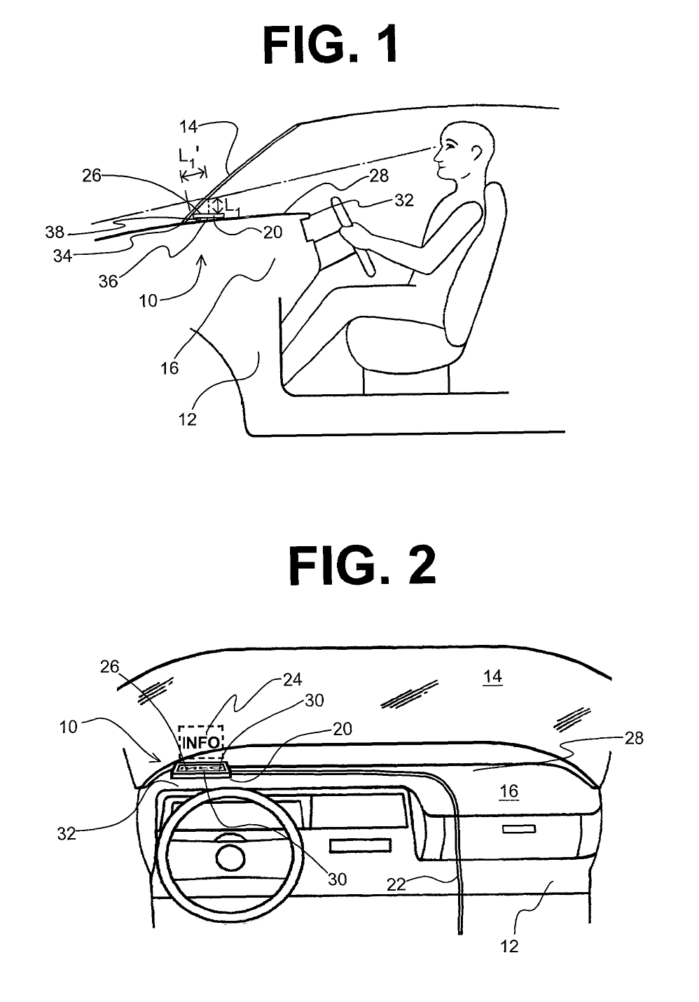

FIG. 1 is a schematic drawing depicting the use of the display device of the present invention to view information below the viewer's line of sight, as viewed from the side of the vehicle;

FIG. 2 is a schematic drawing depicting the use of FIG. 1, as viewed by the driver of the vehicle;

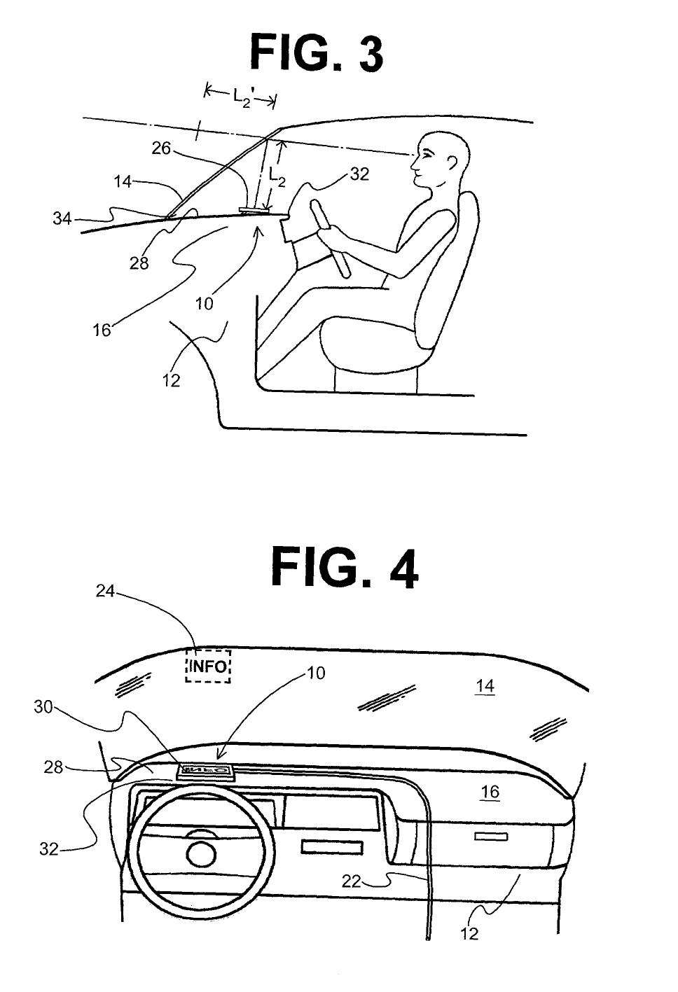

FIG. 3 is a schematic drawing depicting the use of the display device of the present invention to view information above the viewer's line of sight, as viewed from the side of the vehicle;

FIG. 4 is a schematic drawing depicting the use of FIG. 3, as viewed by the driver of the vehicle;

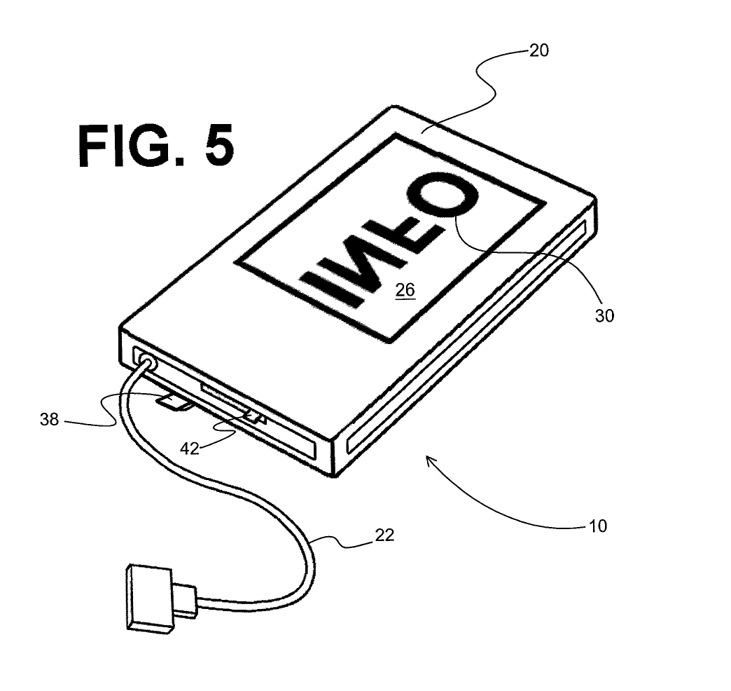

FIG. 5 is a perspective view of the display device of the present invention;

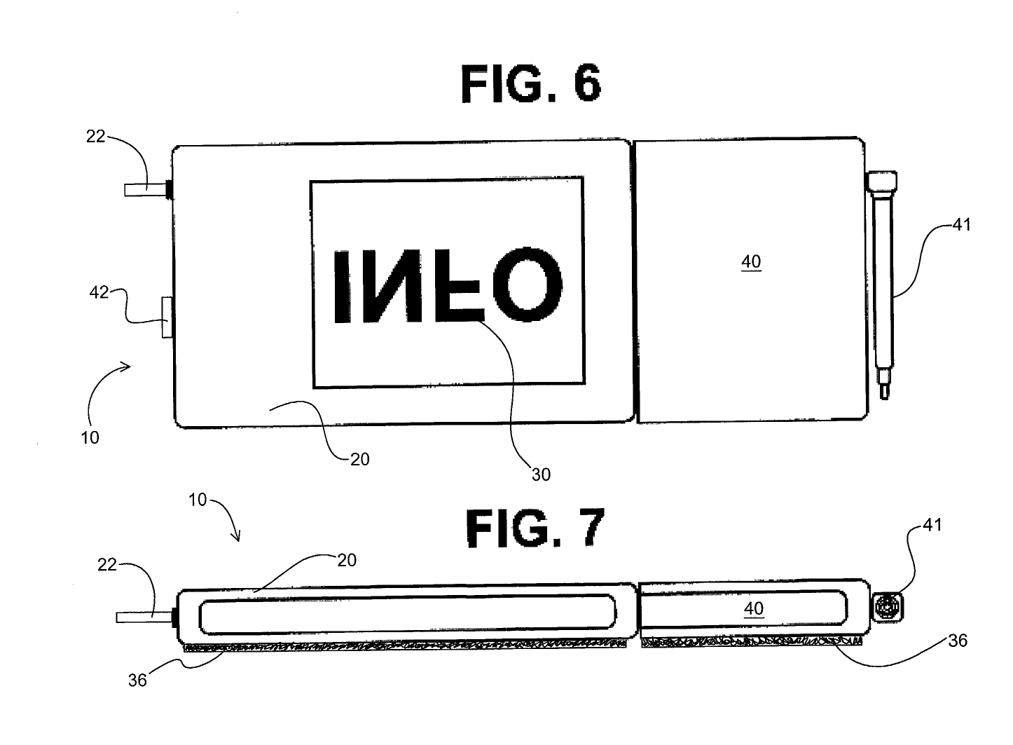

FIG. 6 is a top plan view of the device of FIG. 5;

FIG. 7 is a side plan view of the device of FIG. 5;

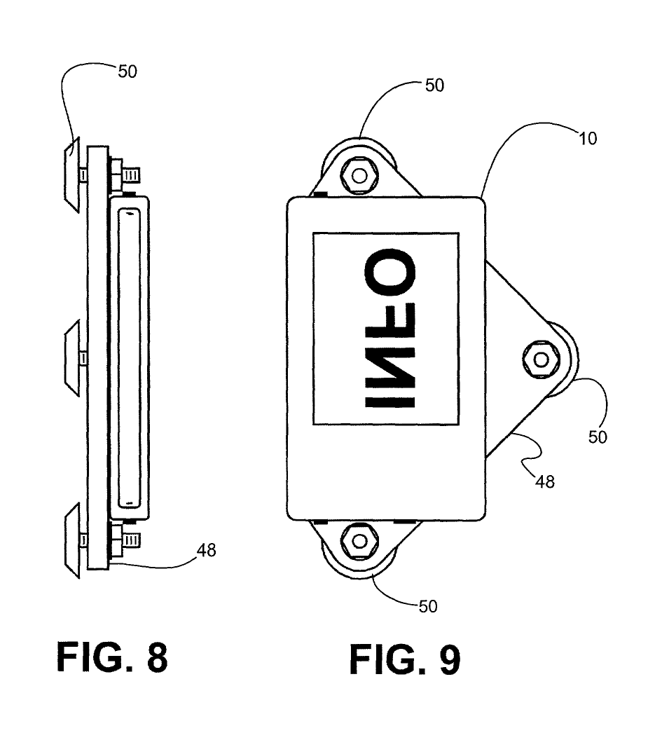

FIG. 8 is a side plan view of the device of FIG. 5 in a mounting stand; and

FIG. 9 is a top view of the device and mounting stand of FIG. 8.

### DETAILED DESCRIPTION OF THE INVENTION

Referring to FIGS. 1 and 2, the present display device, generally designated 10, is intended for use in a vehicle 12 having a windshield 14 and a dashboard 16 or platform at the base of the windshield. The device 10 includes a housing 20, an input device 22 for acquiring information 24 and a display 26 of the information. When resting on an upper surface 28 of the dashboard 16, the display 26 provides the information 24 as a mirror image 30, which is then converted upon reflection from the windshield 14 to a readable virtual image. The position of the information 24 on the windshield 14 is adjustable to accommodate the viewer by moving the location of the device 10.

An important feature of this “projector free” display 26 is that it does not rely on optical power to make the information available to the viewer, but reflects the contents of the display directly off the windshield. Thus, no supplemental lenses or other optical elements are needed to obtain the benefits of the present invention. Because the windshield 14 has a finite thickness, it acts as a combiner. Light from the display 26 portion of the device 10 resting on the upper surface 28 of the dashboard 16 travels upward a distance, L₁, until it intersects the windshield 14. A portion of the light is reflected toward the eye of the viewer from the windshield surface. Since the display 26 is visually reversed from a normal readable format, the reflected image is seen as a virtual mirror image of the real image 30 of the display 26, making the reflected displayed virtual mirror image of the information 24 readable to the viewer, usually the driver of the vehicle 12.

As perceived by the viewer, the information 24 does not appear directly on the windshield 14, but appears as a transparent virtual image in focus at a distance, L₁′, from the windshield toward the front of the vehicle 12. As is well known in the field of optics, L₁=L₁′. Vision is normally restricted to light that travels in a straight line. The viewer does not perceive that the information 24 was reflected, so it is interpreted by his brain as being on a straight-line path from the eye through the windshield 14 to the information 24 at a distance L₁′ past the windshield, outside of the vehicle 12. This property of perception is used to the advantage of the viewer, requiring less of a change in focus when moving from the information 24 to the road ahead of the vehicle 12. The perceived location of the information 24 reduces the reaction time of the viewer when moving his eyes from the road to the information 24 and back, as well as reducing any disorientation caused by focal change because the eye focus change is less severe.

The portability of the display device 10 and the perceived location of the information 24 make it easy to locate the information 24 outside of the viewer's line of sight when an unobstructed view of the road is desired. As used in this description, the viewer's “line of sight” refers to a straight line from the viewer's eye to the portion of the road ahead normally observed by a driver when there are no distractions. When non-critical information 24 is displayed, such as the telephone number of an incoming cellular call, the information 24 can be kept out of the line of sight by proper positioning of the display device 10. If the device 10 is positioned on the upper surface 28 of the dashboard 16, adjacent to the windshield 14, the information is displayed below the viewer's line of sight. To access the information 24, the viewer need only shift his eyes slightly to focus on the transparent information superimposed on hood of the vehicle 12, where the information appears to be focused.

Comparing FIGS. 1 and 2 with FIGS. 3 and 4, movement of the display device 10 changes the location of the information 24 as well as the perceived distance L₁′, L₂′ from the windshield 14 to the information. The device 10 is placed close to the windshield 14 in FIGS. 1 and 2. This position displays the information below the viewer's normal line of sight at a distance L₁′ in front of the windshield. The information 24 can be displayed above the line of sight by positioning the device 10 toward a rear edge 32 of the dashboard 16, shown in FIGS. 3 and 4. However, the information is also perceived to be a longer distance L₂′ from the windshield. Movement of the device 10 to the left or right of the line of sight similarly moves the information 24.

The display device 10 is intended for use in a vehicle 12. Under normal conditions, the device 10 rests on the generally horizontal surface of the dashboard 16 between the rear edge 32 and the windshield 14. Referring to FIGS. 5, 6 and 7, the exact shape of the device 10 is not important, however, a thin profile is advantageous so that the housing 20 can fit close to the narrow area 34 where the windshield 14 meets the dashboard 16.

Referring back to FIG. 1, for long life, the housing 20 is preferably made of materials that are resistant to breakdown by ultraviolet rays or temperature extremes as will be encountered on the dashboard 16 of a vehicle 12. Suitable materials for the housing 20 include, but are not limited to natural or synthetic rubber, wood, metal, glass and some plastics such as ABS, polyurethane, neoprene, poly(methyl)methacrylates, polyimides and polycarbonates. The housing 20 is preferably dark in color so that the housing 20 reflection onto the windshield 14 is minimized. Most preferably, the housing 20 is made of a black semi-ridged material.

Usually, the housing includes a power switch 42, a compartment for one or more batteries to supply power for the display 26, and data transfer or other functions of the device 10. Optionally, the display device 10 is hardwired to a power source, such as a remote power pack or the vehicle electrical system.

As it would be disadvantageous for the device 10 to slide around on the dashboard 16 as the vehicle 12 moves, the housing 20 preferably includes at least a bottom surface 36 adjacent to the upper surface 28 of the dashboard 16 that has a non-slip surface. The non-slip surface 36 is preferably an inherent property of the housing 20 material, as when the housing is made of natural or synthetic semi-ridged material. However, as seen in FIG. 7, a suitable housing 20 can be constructed of other materials and the non-slip surface 36 added to the housing in a separate step. The housing 20 can be made of a hard polished material, for example, and a thin layer of rubber affixed to the bottom of the housing to provide the non-slip surface 36. Preferably the device 10 is fastenable to the dashboard 16 so that the device does not fly off the dashboard during a sudden acceleration or deceleration of the vehicle 12. Loop and hook fastener material, such as Velcro° brand material, (Velcro USA, Inc., Manchester, N.H.) is the preferred method of fastening the device 10 to the vehicle 12.

The input device 22 is disposed in said housing, allowing the device 10 to acquire information 24 to be displayed. Four sources of input are suitable for use with the display device 10. Employment of multiple sources for information 24 is also contemplated. The input is preferably obtained from self-generated data, from an external wireless source, from direct cellular input and/or from being hardwired to another device. Self-generated information is one that is produced by the display device 10 itself. The device 10 optionally has electronic components that allow it to function as a clock or a calculator. External wireless data transfer, such as utilized in Bluetooth™ technology, includes the use of radio frequencies to exchange information to and from electronic devices. The input device 22 optionally has a radio receiver operating on one or more band frequencies including RF, infrared or other frequencies.

Cellular input can also be received by the device 10 by use of an on-board cellular modem. When used in conjunction with a cellular phone, most preferably the two devices are used independently. Installation of the cellular phone in a hands-free device (not shown) is most preferable when the user is driving. The cellular modem of the display device would be programmed to respond to the same telephone number. When the phone rings signaling an incoming call, the cellular modem would also respond to the call, displaying the telephone number of the originator of the call if the viewer has Caller ID service. The driver/viewer could then decide whether or not to answer the call. Dialing, answering or talking on the cellular phone would be done through a hands-free phone. Manual dialing and/or other data input to the cellular phone would be echoed and displayed by the display device 10. Many cellular phones include direct access to the Internet so that e-mail, stock quotes, news, monetary exchange rates and weather reports are easily obtainable. The display device 10, presenting data to the viewer in a less distracting format, would duplicate data sent to the cellular phone.

Most preferably, the information 24 is obtained from a hardwired cable connecting the display device 10 to an electronic device (not shown) such as the vehicle, a portable computer, pager or a PDA. Where the information 24 is obtained from an electronic device, the preferred input device 22 is a cable physically connecting the display device 10 to the electronic device. Any other input device 22 that is known to those in this art is suitable for use with this device 10. Information 24 provided by the vehicle 12 to monitor, provide warnings or data as to special conditions are not excluded from use with this device 10.

A “heads-up” display is one that does not require the viewer to lower his eyes below the dashboard upper surface 28 or refocus on an object closer than the rear edge 32 of the dashboard 16. The display 26 is held in the housing 20, providing the information 24 as a mirror image 30 that is directly reflected off the windshield 14. Any type of flat panel display 26 that reflects on the windshield 14 is useful. Most preferably, the display 26 is a liquid crystal display (“LCD”) screen due to its low power requirements. Either transmissive or passive displays are suitable. Displays using segmented digits, such as those used on calculators are useful. Relatively low-resolution VGA displays, like those used on PDAs are also suitable as are self-illuminating flat panel displays. Any type of self-illuminating display is suitable, including but not limited to electroluminescent displays, electro-fluorescent displays and organic electroluminescent (OEL) displays. Thickness of the display 26 is important as to how close the device 10 fits to the narrow area 34, very thin displays being most preferred. Conventional Cathode Ray Tube displays, which are thick by design, are not applicable in this invention due to their size.

The type of display 26 chosen will also determine the microprocessor, software and drivers needed to operate the display 26. As is known to those skilled in the art of designing displays 26 or applications using them, a processor is needed to convert the information 24 into a form that turns on and off segments or pixels of the display. A combination of software and drivers that is unique to the display 26 allows the processor to complete the conversion. Programming within the processor that is common in the art also allows the display to be shown as a mirror image 30 of the information 24, so that it is readable after being reflected off the windshield 14.

Although not required, coatings or films on the windshield 14 in the vicinity of the information 24 are useful for producing a clearer, brighter image. Polarized films can be used to attenuate light, substantially reducing ghost images that become more visible at night. Coatings and films are known in the art, such as silvered films, that increase the reflection of the information 24, making it appear brighter. Other films, coatings or other ways of maximizing or reducing reflectivity can suitably be used with the present display device 10 to make the information 24 easier for the viewer to read.

The exact format or look of the display 26 is not important to this invention and can vary widely. Either black and white or color displays are suitable. The information 24 can be presented as black on a white or colored background, or the image can be reversed to show white information on a black or colored background, or colored information can be presented on black, white, or colored background. Text, graphics, or a combination of the two can be useful to show the information 24, however, some information 24, such as maps, are better displayed as graphic images. The display 26 can range from a true static display to a true dynamic display, with dynamic displays being most preferred.

Methods of taking a data input and outputting the information 24 to a display 26 are well known to those skilled in the art. Cellular phones, for example, display telephone numbers on the screen as they are dialed. A cellular user having a service that identifies the originating telephone number of an incoming call receives the telephone number data through its antenna and formats the number for display on the small display screen of the phone. Any of these technologies are suitable for receiving data from the input device 22, formatting the data and sending it to the display 26. Preferably a microprocessor is used to configure the information 24 in an appropriate format for the type of display 26 chosen.

In formatting the data sent to the display 26, the data is formatted to show the mirror image 30 of the information 24. As seen by the viewer, the information 24 will have been vertically reversed when reflected by the windshield 14. In order to be readable by the viewer, the mirror image 30 is shown in the display 26 so that, when it is reflected, the original image is viewed as a readable transparent virtual image. Optionally, the display device 10 can have a switch (not shown) to show the information 24 in the correct orientation for direct viewing. This allows the device 10 to be used conveniently by any viewer outside of the vehicle 12 or by a passenger for whom head position changes and eye focus changes pose no safety risk.

Referring to FIGS. 5, 6 and 7, the display 26 is backlit when appropriate to improve visibility of the information 24. Although sunlight or light inside the vehicle may provide sufficient background lighting during the day, backlighting is necessary with LCD displays for night operation. Additional attachment 40 is optionally provided to supply batteries as energy for backlighting. If a backlight is included on the device 10, a variable switch 42 is useful for varying the light level and for turning the light on and off. Automatic backlighting, wherein the backlight is automatically triggered and varied in response to a light sensor, is also contemplated for use with this invention.

The additional attachment 40 can also be used as a receiver for radio or other extravehicular transmissions. An antenna 41 can be either internal or external to the attachment 40.

Optionally, the housing 20 also has one or more legs 38 or a mounting stand 48, as seen in FIGS. 5, 8 and 9. The legs 38 or stand 48 are useful in reducing vignetting, which is the distortion of the information due to the geometry of the windshield 14 and the dashboard 16. Slant of the windshield 14 can range from 30° to 45° in automobiles, and up to 60° for trucks. Reflection from an angle more or less then 45° distorts the image in one dimension only, making the information 24 appear foreshortened while retaining the same width. Use of legs 38 or a stand 48 to change the angle of the display device 10 with respect to the dashboard 16 can reduce this distortion, making the information 24 easier to read. The legs 38 are optionally retractable or the stand 48 is optionally adjustable to accommodate different windshield angles in different vehicles, or to make the display device 10 more compact for transport from one vehicle to another. Retraction of the legs 38 can be accomplished by any method known in the art, but it preferably done by rotating the legs from a position parallel to the bottom surface 36 to a position perpendicular to the bottom surface. This option allows for additional flexibility in positioning the information 24 conveniently for the viewer.

An example of the optional mounting stand 48 is shown in FIGS. 8 and 9. The mounting stand has feet 50 that are independently adjustable in height to tilt the display device 10 as needed to reduce vignetting. Adjustment of the foot 50 height can be accomplished by the use of screw threads with a clamping nut, pushing the foot to overcome a friction fit, or by any other means known in the art.

During use, the display device 10 is placed in the vehicle 12 in a position that locates the information 24 where desired relative to the viewer's normal line of sight. Preferably, the device 10 is turned on to activate the display 26, facilitating choice of a location. Placement of the device 10 near the rear edge 32 of the dashboard 16 generally locates the information 24 above the viewer's line of sight, whereas the information 24 can be located below the line of sight by moving the device forward, closer to the windshield 14.

The input device 22 is activated, if needed, depending on the type of input device utilized. If the input device 22 is a cable, it is connected to the electronic device used to supply the information 24. The antenna 41 on the display device 10 can be adjusted for best reception. Exact steps required for activation of the input device 22 varies with the type of input device used. It is presumed that the electronic device, cellular tower or other source is sending the information 24.

When the display 26 is activated, the information 24 appears on the display as the mirror image 30, which is reflected from the windshield 14 to the eye of the viewer. During reflection, the image is flipped vertically, presenting the original, readable information 24 as a virtual transparent image to the viewer, who perceives the image as being located beyond the windshield 14, toward the front of the vehicle 12. When the image is located above the line of sight, the information 24 can appear to be superimposed on the sky, while if the image is below the line of sight, it appears to be superimposed on the hood of the vehicle 12. While a particular embodiment of the present display device 10 has been shown and described, it will be appreciated by those skilled in the art that changes and modifications may be made thereto without departing from the invention in its broader aspects and as set forth in the following claims.

What is claimed is:

1. A heads-up display device for presenting information to a viewer in a vehicle having a windshield and a dashboard comprising:
a housing being positionable on the dashboard of the vehicle;
an input means disposed in said housing for acquiring extravehicular information;
a display generated in said housing providing said information as a mirror image that is directly reflected off the windshield.

2. The display device of claim 1 wherein said display is generated on a liquid crystal display screen.

3. The display device of claim 1 wherein said device is portable.

4. The display device of claim 3 wherein said housing further comprises a non-slip surface.

5. The display device of claim 1 wherein said input means comprises at least one of a cable to an electronic device and a wireless connection to an electronic device.

6. The display device of claim 5 wherein said electronic device is one of the group comprising a cellular phone, a pager, a computer or a personal data assistant.

7. The display device of claim 1 wherein said housing is portable and freely positionable on the dashboard, and wherein said information is reflected from a location on the windshield, said location determinable by said position of said housing on the dashboard.

8. The display device of claim 1 wherein said display is backlit.

9. The display device of claim 1 wherein said display is self-illuminating such as an electroluminescent device.

10. The display device of claim 1 wherein said extravehicular information comprises one of cellular phone information, maps, directions, stock reports, weather reports, traffic reports, news and travel information.

11. A heads-up display device for presenting information to a viewer in a vehicle having a windshield and a dashboard comprising:
a housing being positionable on the dashboard of the vehicle;
an input means disposed in said housing for acquiring information;
a display generated in said housing, providing said information as a mirror image that is directly reflected from a location on the windshield outside the viewer's direct line of sight.

12. The display device of claim 11 wherein said housing further comprises a non-slip surface.

13. The display device of claim 11 wherein said display is an electroluminescent device.

14. The display device of claim 11 wherein said display is a liquid crystal display.

15. The display device of claim 14 wherein said display is backlit.

16. The display of claim 11 wherein said information is received from outside the vehicle.

17. A heads-up display device for presenting information to a viewer in a vehicle having a windshield and a dashboard comprising:
a portable housing being freely positionable on the dashboard of the vehicle;
an input means in said housing for acquiring information;
a display generated in said housing, providing said information as a mirror image that is directly reflected from a location on the windshield, said location determinable by said position of said housing on the dashboard.

18. The display device of claim 17 wherein said display is generated on a liquid crystal display screen.

19. The display device of claim 17 wherein said information is received from outside the vehicle.

20. The display device of claim 19 wherein said extravehicular information comprises one of cellular phone information, maps, directions, stock reports, weather reports, traffic reports, news and travel information.

21. The display device of claim 17 wherein said information is directly reflected from a location on the windshield outside the viewer's line of sight.

22. The display device of claim 21 wherein said information is extravehicular, said device is portable and wherein said housing is portable and freely positionable on the dashboard, and wherein said information is reflected from a location on the windshield, said location determinable by said position of said housing on the dashboard.
